(19) United States
(12) Patent Application Publication
(10) Pub. No.: US 2005/0066875 A1
(43) Pub. Date: Mar. 31, 2005

(54) Wireless panel for vehicle

(75) Inventor: Chien-Hsing Chen, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Everwell Electronics Co., LTD, Taipei (TW)

(21) Appl. No.: 10/892,643

(22) Filed: Jul. 16, 2004

(30) Foreign Application Priority Data
Sep. 26, 2003 (TW) 092217383

(51) Int. Cl. G08B 1/00

(52) U.S. Cl. 116/200

(57) ABSTRACT

A panel includes a signaling device and a displayer, which are detachably connected to each other. And the signaling device has an infrared emitter to emit a signal to an infrared receiver of the displayer and the displayer shows the signal thereon.

### FIELD OF THE INVENTION

The present invention is related to a panel, and more particularly, to a wireless panel for use in a vehicle.

### BACKGROUND OF THE INVENTION

Please refer to FIG. 1. FIG. 1 is a schematic view showing a conventional panel. Generally speaking, the panel has a signaling device 100 and a displayer 200. The signaling device 100 further has a first case 102 having one or more signal output terminal 106, and a signal wire 108. The signaling device 100 is used for collecting all signals inputted thereinto through the signal wire 108. The case 102 protects the microprocessor or microcomputer (not shown in figures) therein. The microprocessor or microcomputer manages the signals from the signal wire 108 and the signals are then transferred to the signal output terminal 106. The displayer 200 has a second case 202 and a screen 208. The second case 202 includes consisting one or more signal input terminal 206 relative to the signal output terminal 106. When the signaling device 100 and the displayer 200 are engaged with each other, the signal output terminal 106 and the signal input terminal 206 are electrical connected to each other. Therefore, the signal is transferred from the signal output terminal 106 to the signal input terminal 206 and then shown on the screen 208 for display.

The reason that the signaling device 100 and the displayer 200 are detachably removed from each other is because each customer has different needs. Some of them need to read only the speed and mileage of their vehicles. And the other customers want to know more information about their vehicles. So, different customers can chose different displayers 200 to satisfy their needs. Because the displayer 200 and the signaling device 100 are detachable, the signal output terminal 106 and the signal input terminal 206 are designed as detachable. According to the FIG. 1, the terminals 106 and 206 are purely made of metal, which has been developed for a long time. And because the panel is used on the vehicles, the vibrations from the vehicles can be transmitted to the displayer 200 and the signaling device 100, especially the motorcycles and bicycles. Therefore, the vibration makes the displayer 200 and the signaling device 100 has a relative motion therebetween. The connection between the signal output terminal 106 and the signal input terminal 206 are often interrupted by the relative motion because of the vibration of vehicle, which results in that the signal can not be transferred to the displayer 200. Although the terminals 106 and 206 have elastic properties to keep tight electrical connection with each other, under a long time usage, the fatigue of the elasticity will occur sooner or later. The electrical connection between two terminals 106 and 206 will become more unstable. Besides, when the vibration occurs frequently, the collision between two terminals 106 and 206 would impair to each other. Therefore, the reliability of the signaling device 100 and the displayer 200 of the conventional panel is very low.

Furthermore, since the signaling device 100 and the displayer 200 are detachable from each other, the terminals 106 and 206 must be exposed outside of the cases 102 and 202. When the panel is placed on a bicycle or motorcycle, in the bad environments, like rainy days or muddy road, the rain drops, dirt and mud will be jammed between the signaling device 100 and displayer 200. As a result, the objects destroy the terminals 106 and 206 might be corroded or even a shortcut will occur to burn out the signaling device 100 or the displayer 200. It would be time consuming and costly to clean the rust on the terminals 106 and 206.

On the other hand, for resolving the problems resulted from the exposed metal terminals 106 and 206, a radio method is introduced for transmitting the signals between the signaling device 100 and the displayer 200. Because a physical connection for radio transmission is unnecessary, the terminal corrosion resulted by being exposed or the temporal disconnection cause by the vibrations won't effect the signal transmission. At that time, the radio panel is widely used. However, the radio panel is not nearly perfect, because the radio emitting/receiving direction is not easy to control. In fact, the radio emission of the radio signals is emitted to every direction. Therefore, the radio waves of vehicles usually disturb other vehicles or cross talk to each other. Furthermore, the bandwidth is becoming narrower and the overlapping of the radio signals makes other vehicles receive wrong signal, which might render the driver makes a wrong decision. The wrong decisions often cause a great danger on the road. Thus, how to solve the foresaid conventional drawback is the main purpose of the present invention.

### SUMMARY OF THE INVENTION

It is an object of the present invention to provide a panel which would not be affected by vibration, environments, and overlapping radio signals.

According to one aspect of the present invention, a wireless panel includes: a signaling device and a displayer, which are detachably connected to each other. The signaling device has an infrared emitter to emit a signal to an infrared receiver of the displayer and the displayer shows the signal thereon.

In accordance with the present invention, the signaling device further includes a first connector and the displayer further includes a second connector connecting with the first connector, and the first and the second connectors are detachable from each other.

Preferably, the first connector is a concave and the second connector is a block engaging into the concave.

In accordance with the present invention, the signaling device further includes a buckling block and the displayer further includes a buckling concave to for being buckling by the buckling block.

Preferably, the signaling device further includes an emitting window and the displayer further includes a receiving window facing the emitting window.

Preferably, the signaling device and the displayer are transparent to an infrared.

Preferably, the displayer further includes a battery chamber.

Preferably, the signaling device further includes a power output terminal and the displayer further includes a power input terminal to receive an electrical power outputted from the power output terminal of the signaling device.

Preferably, the electrical power is selected from an alternative current and a direct current.

Preferably, the panel is applied to a vehicle.

Preferably, the signaling device is connected to a detector.

Preferably, the detector has a function of detecting one selected from a group consisting of back object, engine rounds, speed, mileage, tire temperature, water temperature, engine oil temperature, brake temperature and air temperature.

Preferably, the vehicle is selected from a group consisting of an aircraft, a ship and a ground vehicle.

Preferably, the ground vehicle is selected from a group consisting of an automobile, a motorcycle, and a bicycle.

Preferably, the signaling device is connected to a generator providing an electric power thereto.

Preferably, the displayer further includes a screen to show the signal.

According to another aspect of the present invention, a wireless panel includes: a signaling device having a first magnetic means; and a displayer detachably connected with the signaling device and has an second magnetic means to sense a magnetic field generated by the first magnetic means so as to show a signal contained in the magnetic field thereon.

In accordance with the present invention, the first magnetic means and the second magnetic means are coils.

In accordance with the present invention, the signaling device has a concave and the displayer has a block engaging into the concave.

In accordance with the present invention, the signaling device further includes a buckling block and the displayer further includes a buckling concave for being buckled by the buckling block.

The foregoing and other features and advantages of the present invention will be more clearly understood through the following descriptions with reference to the drawings, wherein:

### BRIEF DESCRIPTION OF THE DRAWINGS

FIG. 1 is a schematic view showing the panel according to the prior art;

FIG. 2-1 is a literal view showing the panel according to a preferred embodiment of the present invention;

FIG. 2-2 is a schematic view showing a signaling device combined with a displayer according to a preferred embodiment of the present invention;

FIG. 2-3 is a diagram showing the signaling device connected to the displayer from the front of the signaling device and the back of the displayer according to a preferred embodiment of the present invention;

FIG. 3. is a block diagram showing the employment principle according to a preferred embodiment of the present invention;

FIG. 4 is a schematic view showing the transmission of the signal and the electric power according to a preferred embodiment of the present invention; and

FIG. 5 is a oscillogram of signal wave according to a preferred embodiment of the present invention.

### DETAILED DESCRIPTION OF THE PREFERRED EMBODIMENT

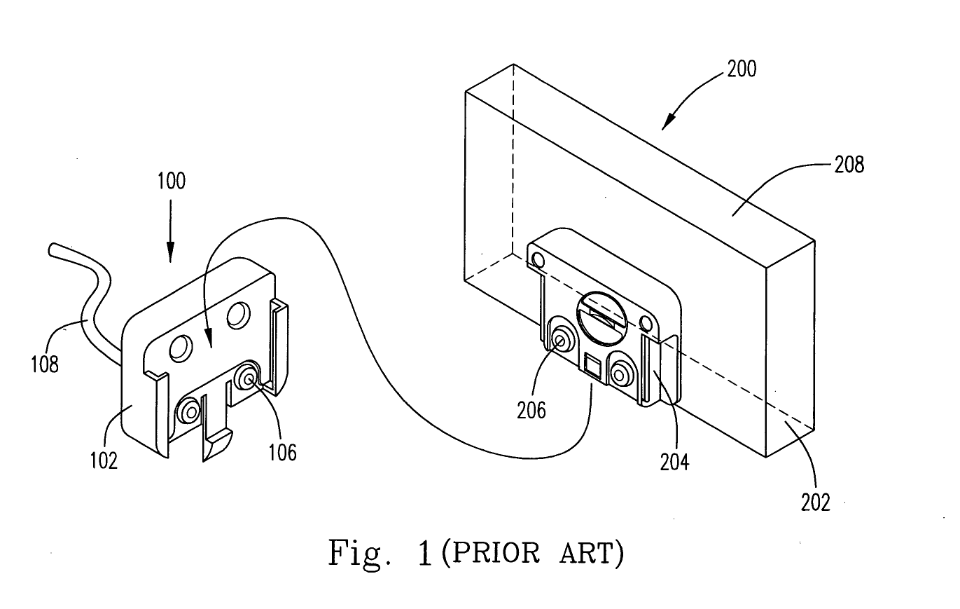

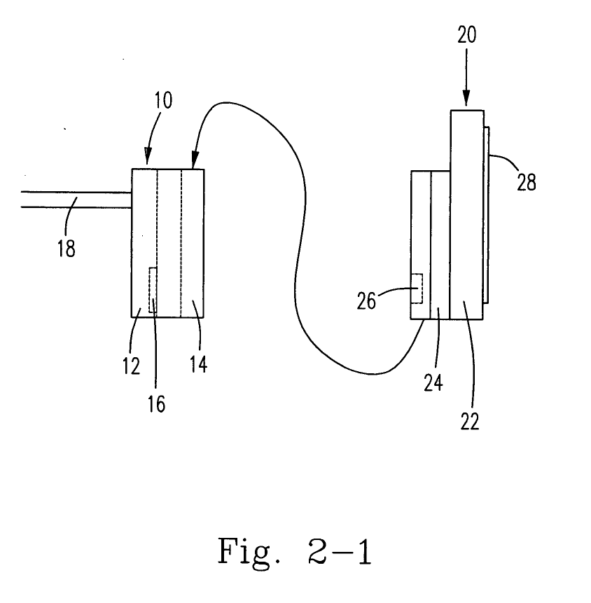

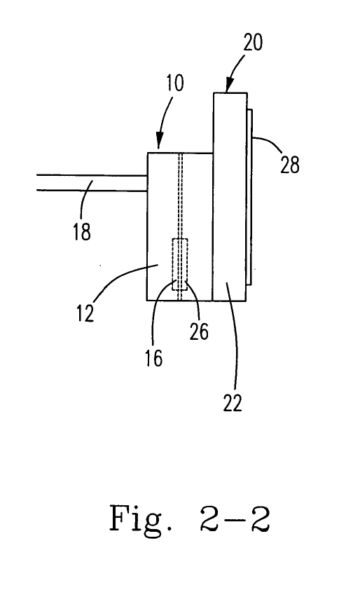

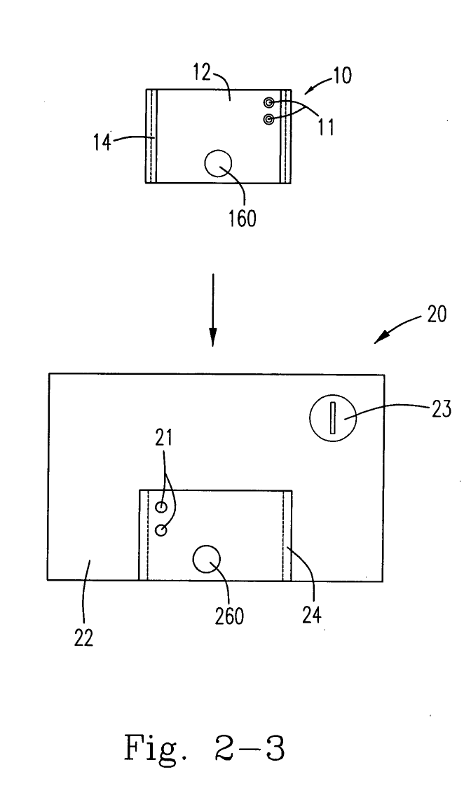

The present invention will now be described more specifically with reference to the following embodiments. Please refer to FIG. 2-1. FIG. 2-1 is a literal view showing the panel of the present invention. The panel includes a signaling device 10 and a displayer 20. The signaling device 10 has a device case 12 having the first connector 14, and an infrared emitter 16. The displayer 20 has a displayer case 22 having the second connector 24, and an infrared receiver 26. The infrared emitter 16 is facing to the infrared receiver 26. Furthermore, the signaling device 10 uses the signal wire 18 to collect signals thereinto. And the displayer 20 has a screen 28 to show the signals transferred from the signaling device 10.

Please refer to FIG. 2-2, which is a schematic view showing a signaling device combined with a displayer according to the present invention. When the first connector 14 and second connector 24 are combined with each other, the infrared emitter 16 is assured to face to the infrared receiver 26. Through the signal wire 18, many kinds of signals are transmitted to the signaling device 10 for signal collecting or further modification. Then, those signals are transmitted to the infrared receiver 26 of the displayer 20 by the infrared emitter 16 and then shown on the screen 28 thereof. Therefore, the panel provided in the present invention will not be influenced by weather, environment, radio wave, or vibration.

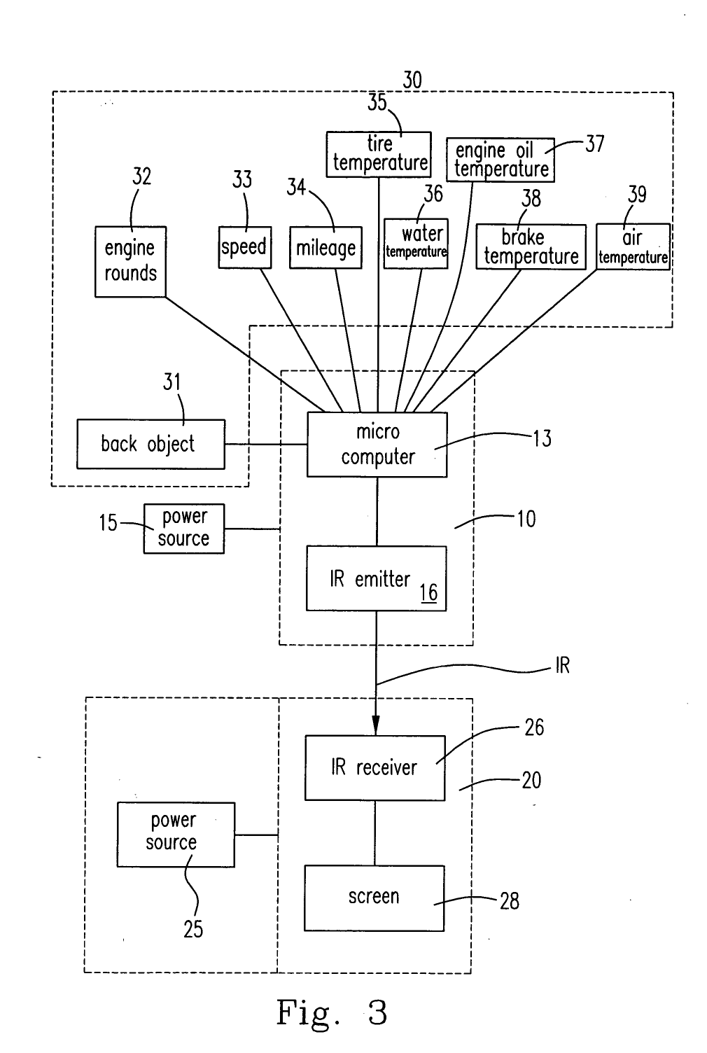

Please refer to FIG. 2-3. FIG. 2-3 is diagram showing the signaling device connected to the displayer from the front of the signaling device and the back of the displayer according to the present invention. The above portion of FIG. 2-3 shows the front view of the signaling device 10, while the below portion shows the backview of the displayer 20. The laterals of the device case 12 are the first connector 14 and the emitting window 160 is placed on the device case 12 for infrared light passing therethrough. The displayer case 22 of the displayer 20 has a second connector 24 for being connected with the first connector 14. The displayer case 22 has a receiving window 260 for the infrared light from the infrared emitter 16 passing therethrough. Furthermore, the displayer 20 has a battery chamber 23 for containing a battery (not shown in all figures) which supplies an electric power to the displayer 20. Certainly, the electric power can be applied to the signaling device 10 through the power output terminal 11 mounted on the signaling device 10. And the power input terminal 21 is mounted on the displayer 20 relative to the position of the power output terminal 11. When the signaling device 10 is combined with the displayer 20, the electric power is supplied to the displayer 20 through the terminals 11 and 21. According to another embodiment of the present invention, the battery chamber 23 has rechargeable function for being recharged the battery by the signaling device 10.

Please refer to FIG. 3. FIG. 3 is a block diagram showing the employment principle of the present invention. The signaling device 10 further has a micro computer 13 connected to a detector 30 having functions of detecting various values including, engine rounds 32, speed 33, mileage 34, tire temperature 35, water temperature 36, engine oil temperature 37, brake temperature 38, and air temperature 39, or the back object 31, such as a vehicle. The micro computer 13 collects and calculates the signals obtained from the detector 30. And then the signal is transmitted to the infrared emitter 16 for being emitted to the infrared receiver 26. The signal is shown on the screen 28 of the displayer 20 so that the driver can estimate a situation of the vehicle. The signaling device 10 is also electrically connected to the power source 15 which is a battery or an electricity generator. If the power source 15 is a generator, the generator is not limited as a AC generator or DC generator. The displayer 20 is also electrically connected to the power source 15, which can be the battery inside the battery chamber 23 or the power source 15 supplied from the signaling device 10.

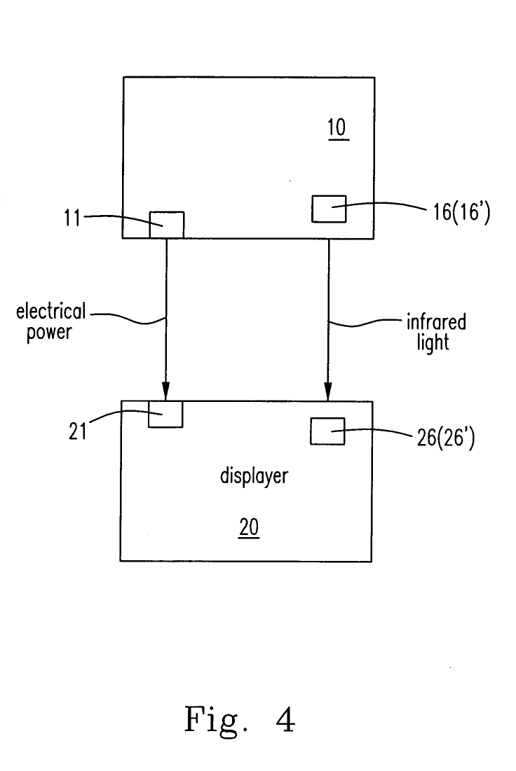

Please refer to FIG. 4, which is a schematic view showing the transmission of the signal and the electric power according to the present invention. Not only the signals are transmitted to the displayer 20 from the signaling device 10, but also the electric power is transmitted from the signaling device 10 to the displayer 20 through the terminals 11 and 21. With regard to the signal transmission, besides the transmission by the infrared emitter 16 and the infrared receiver 26, the wireless transmission can also be achieve by the magnetism between first magnetic means 16′ mounted on the signaling device 10 and the second magnetic means 26′ mounted on the displayer 20.

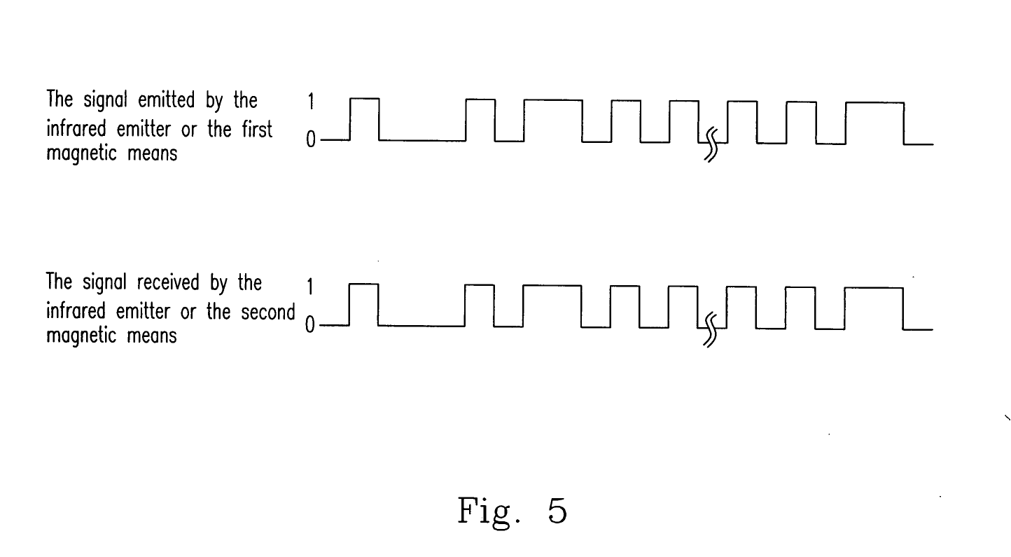

Please refer to FIG. 5, which is a oscillogram of signal wave according to the present invention. The wave of the signal described in the present invention is square wave.

According to another aspect of the invention, the material of the device case 12 and the displayer case 22 can be made of a material transparent to the infrared ray. In such a device, the emitting window 160 and the receiving window 260 are unnecessary, neither the first and second magnetic means 16′ and 26′. Preferably, the first and second magnetic means 16′ and 26 are coils.

According to the above descriptions, the present invention applying the infrared light, or the magnetic field can avoid the use of the contacting terminal. So, the defects occurred by using the contact terminals will not occur to the wireless/contactless signaling apparatus by the present invention. Without the contact terminals 106 and 206, like the prior art in FIG. 1, the problems of the corrosion, loosing, collision and breaking caused by vibration are disappeared. With regard to the infrared emitter 16 and the infrared receiver 26, since the emitting angle of the infrared light is usually limited and is much easier to control than that of the radio wave, as long as a certain distance between the infrared emitter 16 and the infrared receiver 26 is kept, even the infrared emitter 16 and the infrared receiver 26 have been moved relatively motion, the signal still can be transmitted from the infrared emitter 16 to the infrared receiver 26 without any interruption. Even if rain drops fall between the infrared emitter 16 and the infrared receiver 26, the infrared light can pass therethrough. Furthermore, when dirt, mud, or any other external object block between the infrared emitter 16 and the infrared receiver 26, it is very convenient to wash them out by water. Besides, because no metal terminals are exposed outside the device case 12 and the displayer case 22, no corrosion will occur. And also because the emitting/receiving angel of infrared is much easier to control than that of the radio signals, the infrared receiver 26 is not such easy to be interfered as the radio receiving device in conventional radio panel. So, even two vehicles use the same wavelengths of the infrared light, and adjoin to each other, the infrared emitter 16 of one vehicle would not interfere the infrared receiver 26 of the other vehicle and the signal transmitted therebetween would not affected by the vibration either. Hence, the present invention not only has a novelty and progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A panel, comprising:
a signaling device having an infrared emitter to emit a signal; and
a displayer detachably connected with said signaling device and having an infrared receiver to receive said signal from said signaling device and to show said signal thereon.

2. The panel according to claim 1, wherein said signaling device further comprises a first connector and said displayer further comprises a second connector connecting with said first connector, and said first and said second connectors are detachable from each other.

3. The panel according to claim 2, wherein said first connector is a concave and said second connector is a block engaging into said concave.

4. The panel according to claim 1, wherein said signaling device further comprises a buckling block and said displayer further comprises a buckling concave to for being buckled by said buckling block.

5. The panel according to claim 1, wherein said signaling device further comprises an emitting window and said displayer further comprises a receiving window facing said emitting window.

6. The panel according to claim 1, wherein said signaling device and said displayer are transparent to an infrared.

7. The panel according to claim 1, wherein said displayer further comprises a battery chamber.

8. The panel according to claim 1, wherein said signaling device further comprises a power output terminal and said displayer further comprises a power input terminal to receive an electrical power outputted from said power output terminal of said signaling device.

9. The panel according to claim 8, wherein said electrical power is selected from an alternative current and a direct current.

10. The panel according to claim 1, wherein said panel is applied to a vehicle.

11. The panel according to claim 10, wherein said signaling device is connected to a detector.

12. The panel according to claim 11, wherein said detector has a function of detecting one selected from a group consisting of back object, engine rounds, speed, mileage, tire temperature, water temperature, engine oil temperature, brake temperature and air temperature.

13. The method according to claim 10, wherein said vehicle is selected from a group consisting of an aircraft, a ship and a ground vehicle.

14. The method according to claim 13, wherein said ground vehicle is selected from a group consisting of an automobile, a motorcycle, and a bicycle.

15. The panel according to claim 1, wherein said signaling device is connected to a generator providing an electric power thereto.

16. The panel according to claim 1, wherein said displayer further comprises a screen to show said signal.

17. A panel, comprising:
an signaling device having a first magnetic means; and
a displayer detachably connected with said signaling device and has an second magnetic means to sense a magnetic field generated by said first magnetic means so as to show a signal contained in said magnetic field thereon.

18. The panel according to claim 17, wherein said first magnetic means and said second magnetic means are coils.

19. The panel according to claim 17, wherein said signaling device has a concave and said displayer has a block engaging into said concave.

20. The panel according to claim 17, wherein said signaling device further comprises a buckling block and said displayer further comprises a buckling concave for being buckled by said buckling block.

21. The panel according to claim 17, wherein said displayer further comprises a battery chamber.

22. The panel according to claim 17, wherein said signaling device further comprises a power output terminal and said displayer further comprises a power input terminal to receive an electrical power outputted from said power output terminal of said signaling device.
